(19) United States
(12) Patent Application Publication
(10) Pub. No.: US 2005/0003063 A1
(43) Pub. Date: Jan. 6, 2005

(54) Method for preparing an extruded food product

(76) Inventor: Jacobus Petrus Johannes Kobussen, Veghel (NL)

Correspondence Address: Richard S Roberts, PO Box 484, Princeton, NJ, 08542-0484, US

(21) Appl. No.: 10/488,436

(22) PCT Filed: Aug. 27, 2002
(86) PCT No.: PCT/NL02/00563

(30) Foreign Application Priority Data
Sep. 3, 2001 (NL) 1018871

(51) Int. Cl. A01J 1/00

(52) U.S. Cl. 426/516

(57) ABSTRACT

The present invention relates to a method for preparing an extruded food product, which method comprises the steps of i) simultaneously co-extruding the food product and a curable coating on the outer surface of the food product ii) passing the food product that has been subjected to the co-extruding step in step i) through a coagulation bath, and iii) subjecting the food product from step ii) to further treatment.

The present invention relates to a method for preparing an extruded food product, which method comprises the steps of

i) simultaneously co-extruding the food product and a curable coating on the outer surface of the food product,

ii) passing the food product that has been subjected to the co-extruding step in step i) through a coagulation bath, and

iii) subjecting the food product from step ii) to further treatment.

Such a method is known per se from International patent application WO 99/44431, which has been filed in the name of the present applicant, in which it is stated that the contact time with the brine bath is preferably 20-60 seconds and that the salts must have a dissolution rate of at least 8 mol/l water at a temperature of 20° C. Although the group of casein, soy, wheat, cellulose, alginate, chitosan or starch is mentioned as coating materials, no further details on the individual members of said group are provided.

From International patent application WO 99/30568, which has been filed in the name of the present applicant, it is known that the gel that is used as the curable coating contains collagen, with the possible addition of other components such as cellulose fibres, organic acids and plasticisers.

International patent application WO 01141576 further makes mention of the fact that the coagulation solution contains sodium phosphate or potassium phosphate, with a layer of collagen gel being used as the coating.

The method referred to in the introduction is known per se from Dutch patent application No 9400602, which has been filed in the name of the present applicant. This known method is generally used for co-extruding sausage or sausage-like materials. In the main, said method comprises the extrusion of a cylinder-shaped core of a sausage mixture and the simultaneously extrusion of an outer casing around the sausage mixture, which outer casing consists of a gel comprising collagen protein. The proteins in the gel are crosslinked by means of a coagulant, with the water content of the extruded gel casing being reduced through osmosis by passing the food strand through a concentrated brine bath. After this treatment, the mechanical properties of the casing are insufficient to allow for twist linking, clipping or hanging of the sausage strand, however. With the usual method the co-extruded strand of foodstuff is crimped and cut into individual elements, which elements are placed in a hot air dryer for the treatment of individual elements. One drawback of this method is that the organoleptic qualities of the sausage that is produced are inferior to those of sausages provided with a natural or artificial casing. In addition to that, the conventional methods use a casing which fully envelopes the meat mass in a strong and flexible manner during further treatment and which gives the sausage its well-known shape.

A similar method is known from International patent application WO 93/12660, which method is aimed at avoiding the aforesaid problems. Said known method likewise comprises the steps of co-extruding a substantially uniform layer of a collagen gel around an extruded food product and chemically coagulating the collagen gel that has been extruded together with the food product, using a chemical coagulant, which method does not employ a hot air drying step for forming a coagulated collagen casing around the edible foodstuff which is sufficiently strong for realising a mechanical separation of the interconnected individual food elements, in particular sausages.

Experiments have shown that a collagen gel of an edible foodstuff subjected to a co-extrusion step which has been produced in accordance with said method is not strong enough to undergo the usual further treatments. A consequence of said low strength of the casing is furthermore the fact that the casing of the sausage strand is not uniform, in particular not uniform enough for specific further treatments. When strands of edible foodstuffs that have then produced in this manner are hung up, for example, the “liquid” meat mass will sag towards the lower end, giving the edible foodstuff a conical shape. Such a shape is undesirable for sausages. In addition, if the gel casing is not sufficiently strong, tears may form when a load is being exerted on the casing. Consequently, the production rate is furthermore adversely affected with this known method as a result of the casing not being sufficiently strong and its shape not being sufficiently stable yet. Another disadvantage is that the concentration of salt in both the casing and the meat mixture is too high, due to the long residence time in the coagulation bath. As a result, the organoleptic and physical properties of the sausage mixture, for example the taste, the consistency and the solidity of the meat mixture, are liable to change.

In particular, the aforesaid methods are insufficiently aimed at the stabilisation problem of the collagen casing. Drying with air is still an important feature of the aforesaid methods, which treatment makes the cost of preparing fresh and dried sausage undesirably high. In addition, the aforesaid methods are insufficiently aimed at the fact that the fresh sausage casing tends to remoisturise or rehydrate. This means that the moisture content of the casing will increase after some time. Said increase in the moisture content causes the casing to gel upon frying of the fresh sausage, which is undesirable as regards the eventual consumption.

Thus the present inventor aims at preventing the destabilisation that occurs in the casing due to the remoisturising of the protein structure, in particular collagen.

Consequently it is an object of the present invention to provide a method for preparing an extruded food product in which the step of drying the extruded food product, which is necessary in the prior art, can be omitted.

Another object of the present invention is to provide a method for preparing a food product that has been subjected to a co-extrusion treatment, which method reduces or even eliminates the phenomenon of undesirable shrinkage of the curable coating that has been subjected to a co-extrusion treatment without destabilisation of the casing occurring.

Another object of the present invention is to provide a method for preparing an extruded food product in which it is possible to wash the food product that has been subjected to a co-extrusion treatment with water after treatment thereof in the coagulation bath.

The present invention as referred to in the introduction is characterized in that the curable coating comprises an edible protein and chitosan, which chitosan has a deacetylation degree of 60-100%.

The special combination of an edible protein and chitosan as the main component of the curable coating, combined with the special deacetylation degree of 60-100%, preferably 75-99%, makes it possible to accomplish the present objectives.

It is in particular preferable to obtain the curable coating by first acidifying chitosan to form a solution or slurry of 2-10 wt. %, which has a pH value of 2-5, and acidifying the edible protein to a pH value of 2-5, after which the two compositions are mixed.

In certain embodiments it is moreover desirable to mix chitosan and edible protein first and subsequently acidify the obtained mixture to a pH value of 2-5.

It is in particular desirable to carry out step ii) in such a manner that:
80<o.t.<1500

wherein:

o=the osmolarity of the coagulation bath, measured at 20° C., and

t=the residence time in the bath (sec).

The special way of carrying out step ii) makes it possible to omit the drying step that is known from the prior art. The omission of such a drying step is desirable in particular from an economic point of view. In addition, the food product has undergone such cross-linking of the coating after leaving the coagulation bath that any excess of coagulating fluid can be removed by washing. It is in particular preferable to carry out step ii) in such a manner that 300<o.t.<900.

Advantageous results are obtained with the present method if step ii) is carried out in such a manner that the residence time in the coagulation bath is 5-60 seconds, in particular if step ii) is carried out in such a manner that the residence time in the coagulation bath is 10-40 seconds. These values are mainly dictated by the desired mechanical strength of the final coating. In addition, a proper mixing of edible protein and chitosan must be obtained, which will lead to problems in the case of deacetylation degrees outside the aforesaid range.

Although a curable coating with a base of a mixture of collagen and chitosan is known from Japanese patent application JP-4-262733, said Japanese patent application does not provide any information whatever with regard to the desired degree of dehydration in the coagulation bath that is desired by the present invention. Since said Japanese patent application employs the so-called Protecon system, which system in fact comprises a shorter residence time in the coagulation bath, generally shorter than 4 seconds, and a necessary drying step using drying ovens, and consequently effects a dehydration of maximally 10 wt. %, the products that leave the coagulation bath will have to be dried in an additional drying step, which drying step can be omitted according to the present invention. In addition to that, no further details as regards the deacetylation degree are known from said Japanese patent application.

Although a method as referred to in the introduction is also known from Japanese patent application JP-4-058872, chitosan is used in combination with metal ions in the coagulation bath rather than in the present curable coating, however, before extrusion takes place.

The expression “coagulation” as used in the present description is a technical term which is used in the production of collagen-coated sausage material, it is not meant to be a scientific description. Coagulation as employed in the present application relates to the step of forming and stabilising the casing. In fact, it is obtained in two ways, in the first place by dehydrating protein, in particular the collagen gel, or removing water therefrom, and in the second place by crosslinking the collagen fibres. The execution of a crosslinking reaction prevents rehydration of the dehydrated coating or casing. Such crosslinking can be regarded as the forming of molecular links between the collagen fibres. If such crosslinking does not take place, the hydrophilic protein-, in particular collagen-containing casing or coating will attract moisture both from the encased foodstuff and from the external environment thereof.

According to the present invention it is preferable to formulate the composition of the coagulation bath to realise a dehydration of the coating in the order of at least 15%, in particular 20-60%, especially preferably 30-40%. The temperature of the coagulation bath ranges from 10-40° C. The pH value of the coagulation bath preferably ranges from 7-11. The term “coagulation bath” that is used herein is understood to mean any manner of contacting with a coagulating fluid, such as spraying, immersing, showering, painting or curtain, with several combinations thereof being possible as well, for example a combination of two baths arranged in succession, or a combination of a bath and a spraying element arranged after said bath. Furthermore it is preferable to wash the extruded product from step ii) for the purpose of removing any coagulant adhering thereto, in which in particular water is used as the washing liquid. It should be understood that the coagulation treatment comprises the contacting of the coating of the food product with a coagulating fluid. Such a contacting step may comprise a number of sub-steps, in which the product from step i), which may or may not have been separated into individual elements, is subjected to one or more treatments with coagulating fluid. In addition, such a contacting step is understood to include the passage through a bath, the spraying of a coagulating fluid and similar operations. For the sake of clarity, the term coagulation bath is consistently used in the present description. Furthermore it is possible to separate the product obtained after step ii) into smaller parts, in particular through constriction thereof.

The coagulation bath preferably comprises one or more salts having a dissolution rate of at least 4 mol/l water at a temperature of 20° C., with in particular sodium chloride, potassium carbonate or dipotassium phosphate or a combination thereof being used.

Furthermore it has appeared to be advantageous to bring the curable coating with a base of a combination of protein and chitosan into contact with one or more chemical crosslinking agents prior to the extrusion step, for example by injecting the crosslinking agent into the gel flow or, on the other hand or additionally thereto, by introducing such crosslinking agents into the coagulation bath. Suitable chemical crosslinking agents include: glutaraldehyde, glyoxal, liquid smoke, sugars and mineral tannins, and derivatives therefrom or combinations thereof.

The proportion between edible protein and chitosan, based on dry weight, preferably ranges from 95:5 to 70:30.

Suitable edible proteins include proteins of vegetable or animal origin, such as the animal proteins in particular selected from the group of proteins from eggs, casein, gelatin, collagen, elastin and/or derivatives therefrom, and the vegetable proteins selected from the group of wheat gluten, soy protein, proteins from peas and the like, and/or derivatives therefrom and/or combinations thereof. It is preferred to use collagen.

In accordance with the present invention, chitosan (deacetylated chitin) combined with said protein are used as the main components of the coating-forming material. Preferably, chitosan is added to the protein, in particular collagen, in dry form, or alternatively it is dissolved in acidified water first. Preferably, chitosan is present in the gel that is eventually to be extruded in an amount of 2-25 wt. %, preferably 10-15 wt. %, based on the dry weight of the protein. The deacetylation degree of chitin for forming chitosan preferably ranges between 60-100%, in particular 75-99%, which values are mainly dictated by the desired mechanical strength of the final coating. In addition, a proper mixing of edible protein and chitosan must be obtained, which will lead to problems in the case of deacetylation degrees outside the aforesaid range. The coating-forming material preferably has a dry weight of 3-20%.

In a special embodiment, an acid, preferably an acid selected from the group of hydrogen chloride, lactic acid, acetic acid and citric acid, or a combination thereof, is added to the material that forms the curable coating, so as to obtain a desired pH value of 2-5. Such a degree of acidity is in particular desirable in order to effect slight swelling of the protein and the chitosan, so that the coating will form a sound film round the food product.

Although the applicants on no account wish to be tied to a special theory, it is assumed that the abundance of free amino groups of chitosan significantly contributes towards the formation of chemical bonds between chitosan, the protein and the other substances that may be present in the gel material to be extruded. Thus, only limited amounts of crosslinking agents are required in order to give the coating that has been subjected to a co-extrusion step a sufficient degree of stability.

In order to realise a vigorous coagulation treatment, it is preferred to carry out a simple treatment with a highly soluble saline solution, such as dipotassium phosphate, in the coagulation bath. In such an embodiment, a contact time of 25-60 seconds generally suffices for effecting the desired dehydration of the coating material.

Using the present invention, it is possible to wash the extruded strand thoroughly with water after it has left the coagulation bath in order to remove the salts that are still present on the surface without the casing disintegrating or being remoisturised. In addition to preventing the occurrence of negative taste effects on the sausage material, the removal of an excess of salt is important with a view to preventing the crystallization of salts on the final product, a problem which mainly occurs with dried sausages.

The essence of the present invention is thus the special composition of the curable coating as well as a special composition of the coagulation bath, in which the curable coating comprises an edible protein and chitosan, which chitosan has a specific deacetylation degree. In addition to that, the coagulation bath is composed in such a manner that the coating is dehydrated to a sufficient degree. These aspects make it possible to eliminate the air drying step that is known from the prior art, which provides a significant economic benefit. In addition, the foodstuffs leaving the coagulation bath can be washed with water without any risk of the coating becoming dehydrated or unstable, which has not been possible so far.

1. A method for preparing an extruded food product, which method comprises the steps of i) simultaneously co-extruding a food product and a curable coating on the outer surface of the food product, ii) passing the food product that has been subjected to the co-extruding step in step i) through a coagulation bath, and iii) subjecting the food product from step ii) to further treatment, wherein the curable coating comprises an edible protein and chitosan, which chitosan has a deacetylation degree of 60-100%.

2. The method according to claim 1, wherein said chitosan has a deacetylation degree of 75-99%.

3. The method according to claim 1 wherein the curable coating is obtained by first acidifying chitosan to form a solution or slurry of 2-10 wt. %, which has a pH value of 2-5, and acidifying the edible protein to a pH value of 2-5, after which the solution or slurry and the acidified edible protein are mixed.

4. The method according to claim 1 wherein the chitosan and edible protein are first mixed to form a mixture, after which the obtained mixture is acidified to a pH value of 2-5.

5. The method according to claim 1 wherein step ii) is carried out in such a manner that:
80<o.t.<1500
wherein: o=the osmolarity of the coagulation bath, measured at 20° C., and t=the residence time in the coagulation bath in seconds.

6. The method according to claim 5, wherein step ii) is carried out in such a manner that 300<o.t.<900.

7. The method according to claim 1 wherein step ii) is carried out in such a manner that the residence time in the coagulation bath is 5-60 seconds.

8. The method according to claim 7, wherein step ii) is carried out in such a manner that the residence time in the coagulation bath is 10-40 seconds.

9. The method according to claim 1 wherein the coagulation bath comprises one or more salts having a dissolution rate of at least 4 mol/l water at a temperature of 20°0 C.

10. The method according to claim 1 wherein the coagulation bath comprises one or more salts selected from the group consisting of sodium chloride, potassium carbonate and dipotassium phosphate.

11. The method according to claim 1 wherein the temperature of the coagulation bath is 10-40° C.

12. The method according to claim 1 wherein the pH value of the coagulation bath is 7-11.

13. The method according to claim 1 wherein the curable coating further comprises one or more chemical crosslinking agents.

14. The method according to claim 1 wherein the coagulation bath further comprises one or more chemical crosslinking agents.

15. The method according to claim 13 wherein said chemical crosslinking agent is selected from the group of consisting of glutaraldehyde, glyoxal, liquid smoke, sugars and mineral tannins and derivatives therefrom of and combinations thereof.

16. The method according to claim 1 wherein the proportion between edible protein and chitosan, based on dry weight, ranges from 95:5 to 70:30.

17. The method according to claim 1 wherein prior to step ii) the curable coating has a dry weight of 3-20% based on the combined weight of the food product and the curable coating.

18. The method according to claim 1 further comprising washing the extruded product from step ii) for the purpose of removing coagulation bath fluid adhering thereto.

19. The method according to claim 18, wherein said washing is carried out with water.

20. The method according to claim 1 wherein said edible protein is protein of vegetable or animal origin.

21. The method according to claim 20, wherein said animal protein is selected from the group consisting of proteins from eggs, casein, gelatin, collagen, elastin and derivatives therefrom and combinations thereof.

22. The method according to claim 21, wherein said animal protein comprises collagen.

23. The method according to claim 20, wherein the vegetable protein is selected from the group consisting of wheat gluten, soy protein, proteins from peas and derivatives therefrom and combinations thereof.

24. The method according to claim 1 wherein said curable coating furthermore comprises one or more additives selected from the group consisting of polysaccharides, plasticizers, colorants and glycolaminoglycan compounds.

25. The method according to claim 1 wherein the product obtained after step ii) is separated into smaller parts by constriction thereof.
